(19) United States
(12) Patent Application Publication
(10) Pub. No.: US 2026/0126521 A1
(43) Pub. Date: May 7, 2026

(54) ACCURATE MULTI-OBJECT TRACKING FOR EXTENDED REALITY SYSTEMS

(71) Applicant: The Regents of the University of California, Oakland, CA (US)

(72) Inventors: Aditya ARUN, Oakland, CA (US); Shunsuke SARUWATARI, Oakland, CA (US); Dinesh BHARADIA, Oakland, CA (US); Sureel SHAH, Oakland, CA (US)

(21) Appl. No.: 19/491,258

(22) PCT Filed: Jun. 14, 2024
(86) PCT No.: PCT/US2024/034195

§ 371 Date: Dec. 8, 2025

Related U.S. Application Data
(60) Provisional application No. 63/508,849, filed on Jun. 16, 2023.

(51) Int. Cl. G01S 7/41; G01S 7/295

(52) U.S. Cl. CPC G01S 7/41; G01S 7/2955

(57) ABSTRACT

In some embodiments, there is provide a method including receiving, by a locator comprising a plurality of antennas, at least one signal received from a first tag; measuring, by the locator, a time of arrival of the at least one signal and a phase of the at least one signal; determining, by the locator, a location estimate for the first tag, wherein the location estimate is determined based on at least the measured time of arrival and the measured phase; and outputting, by the locator, the determined location estimate for the first tag. Related system, methods, and articles of manufacture are also disclosed.

### CROSS-REFERENCE TO RELATED APPLICATION

The present application claims priority to U.S. Provisional Patent Appl. No. 63/508,849 to Arun et al., filed Jun. 16, 2023, and entitled “ACCURATE MULTI-OBJECT TRACKING FOR EXTENDED REALITY SYSTEMS,” and incorporates its disclosure herein by reference in its entirety.

### TECHNICAL FIELD

The present disclosure generally relates to object tracking.

### BACKGROUND

Understanding the location of objects and people in the real world is a key to many use cases including for example enabling a smooth cyber-physical transition. However, most localization systems today require the deployment of multiple antennas (also referred to as “anchors”) dispersed throughout the environment, and these multiple antennas can be very cumbersome to setup.

### SUMMARY

In some example embodiments, there may be provided object tracking.

In some embodiments, there is provided a method that includes receiving, by a locator comprising a plurality of antennas, at least one signal received from a first tag; measuring, by the locator, a time of arrival of the at least one signal and a phase of the at least one signal; determining, by the locator, a location estimate for the first tag, wherein the location estimate is determined based on at least the measured time of arrival and the measured phase; and outputting, by the locator, the determined location estimate for the first tag.

In some implementations, the current subject matter may include one or more of the following optional features. The plurality of antennas is configured within a 1 meter or less distance. The measuring further includes determining, using the time of arrival of the at least one signal, a time difference of arrival between at least a pair of antennas of the plurality of antennas. The measuring further includes determining, using the phase of the at least one signal, a phase difference of arrival between at least a pair of antennas of the plurality of antennas. The location estimate is determined using the phase difference of arrival between at least the pair of antennas and the time difference of arrival between at least the pair of antennas. The location estimate is determined using an optimization of at least the phase difference of arrival and the time difference of arrival. The optimization uses packet filters to determine the location estimate. The at least one signal is an ultrawideband pulse signal, a Bluetooth signal, WiFi, or a Bluetooth low energy signal. The plurality of antennas is configured within a 1 meter or less distance. The method further includes controlling transmission of the first tag and a second tag; receiving, by the locator, at least another signal from the second tag; determining, by the locator, the location estimates for the first tag and a second location estimate for the second tag; and outputting, by the locator, the determined location estimates for the first tag and the second tag.

In some embodiments, there is provided a system that includes at least a plurality of antennas each coupled to a receiver configured to receive at least one signal received from at least a first tag; and at least one processor and at least one memory including instructions which when executed by the at least one processor causes operations including measuring a time of arrival of the at least one signal and a phase of the at least one signal; determining a location estimate for the first tag, wherein the location estimate is determined based on at least the measured time of arrival and the measured phase; and outputting the determined location estimate for the first tag.

In some implementations, the current subject matter may include one or more of the following optional features. The plurality of antennas is configured within a 1 meter or less distance. The measuring further comprises determining, using the time of arrival of the at least one signal, a time difference of arrival between at least a pair of antennas of the plurality of antennas. The measuring further includes determining, using the phase of the at least one signal, a phase difference of arrival between at least a pair of antennas of the plurality of antennas. The location estimate is determined using the phase difference of arrival between at least the pair of antennas and the time difference of arrival between at least the pair of antennas. The location estimate is determined using an optimization of at least the phase difference of arrival and the time difference of arrival. The optimization uses packet filters to determine the location estimate. The at least one signal is an ultrawideband pulse signal, a Bluetooth signal, WiFi, or a Bluetooth low energy signal. The plurality of antennas is configured within a 1 meter or less distance. The system further includes controlling transmission of the first tag and a second tag; receiving, by the locator, at least another signal from the second tag; determining, by the locator, the location estimates for the first tag and a second location estimate for the second tag; and outputting, by the locator, the determined location estimates for the first tag and the second tag.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A depicts an example deployment of a tag being located by a plurality of antennas and corresponding receivers dispersed throughout a room, in accordance with some embodiments;

FIG. 1B depicts an example system including a locator that detects the location of the tag located in a region, in accordance with some embodiments;

FIG. 2 depicts an example of a system including a locator and one or more tags located in a region, in accordance with some embodiments;

FIG. 3 depicts an example of a process at a locator for locating one or more tags, in accordance with some embodiments;

FIG. 4 depicts heat maps of PDoA and TDoA using different quantity of antennas, in accordance with some embodiments;

FIG. 5 depicts another example of a system including the locator and the one or more tags, in accordance with some embodiments;

FIG. 6A depicts an example implementation of an antenna and receiver, in accordance with some example embodiments;

FIG. 6B depicts an example of a channel impulse response of a received signal from a tag, in accordance with some embodiments; and

FIG. 7 depicts an example of an apparatus including at least one processor, in accordance with some embodiments.

### DETAILED DESCRIPTION

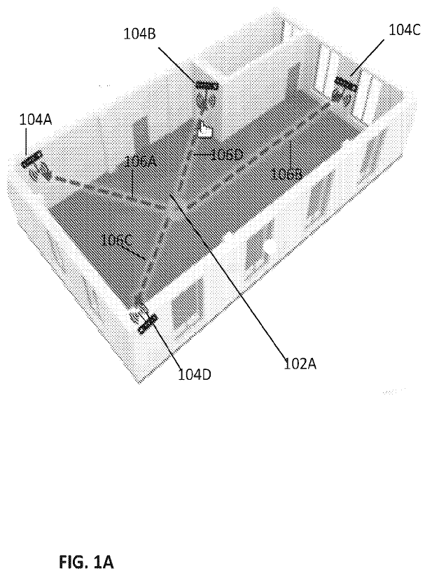

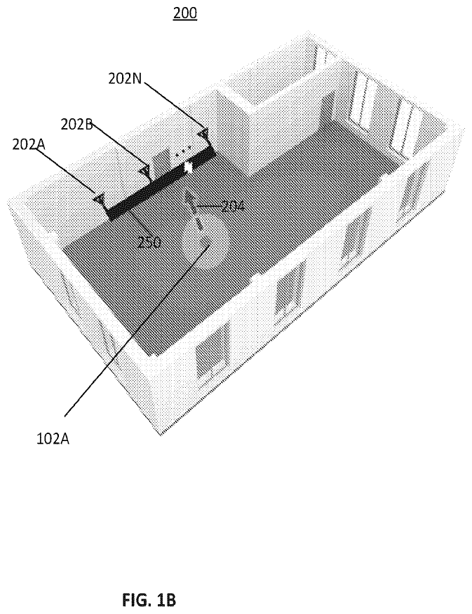

FIG. 1A depicts an example deployment of a tag 102A being located in a region (also referred to as an “environment”) by a plurality of antennas 104A-D dispersed throughout the room. The antennas 104A-D (each of which may be coupled to a receiver) are able to locate the tag 102A by receiving and processing the signals 106A-D transmitted by the tag 102A. Although the antennas 104A-D can locate the tag 102A, the use of antennas dispersed at distances of more than a meter apart (as depicted at FIG. 1) may not be practical in all situations.

In some embodiments, there is provided a locator that includes a plurality of antennas spaced such that the distance between the first antenna and the last antenna is 1 meter or less in distance. The locator receives signals from at least a first tag. The locator then processers the received signal(s) to determine time of arrival of the signal(s) (e.g., time divisional of arrival (TDoA) and a phase of the signal(s) (e.g., phase difference of arrival (PDoA)). For example, pairs of antennas at the locator can receive signal transmitted by a tag and from the received signal measure PDoA between antenna pairs and TDoA between antenna pairs. The TDoA measurements are used jointly with the PDoA measurements to reduce the error in the location estimates for the tag. In this way, the tag can be localized within a few centimeters or less using the plurality of antennas spaced within 1 meter or less.

FIG. 1B depicts an example of a system 200 including a locator 250 and at least one tag 102A located in a region. Unlike FIG. 1A, the system 200 of FIG. 1B uses the locator 250 that includes a plurality of antennas 202A-N spaced such that the distance between the first antenna 202A and the last antenna 202N is 1 meter or less in distance. And, the corresponding receiver(s) of the plurality of antennas 202A-D process (e.g., down covert, analog-to-digital convert, etc.) the received signal(s) and measure time of arrival (e.g., TDoA) of the received signal(s) and phase of arrive (e.g., PDoA) of the received signal(s) to provide a location estimate for the tag 102A, in accordance with some embodiments.

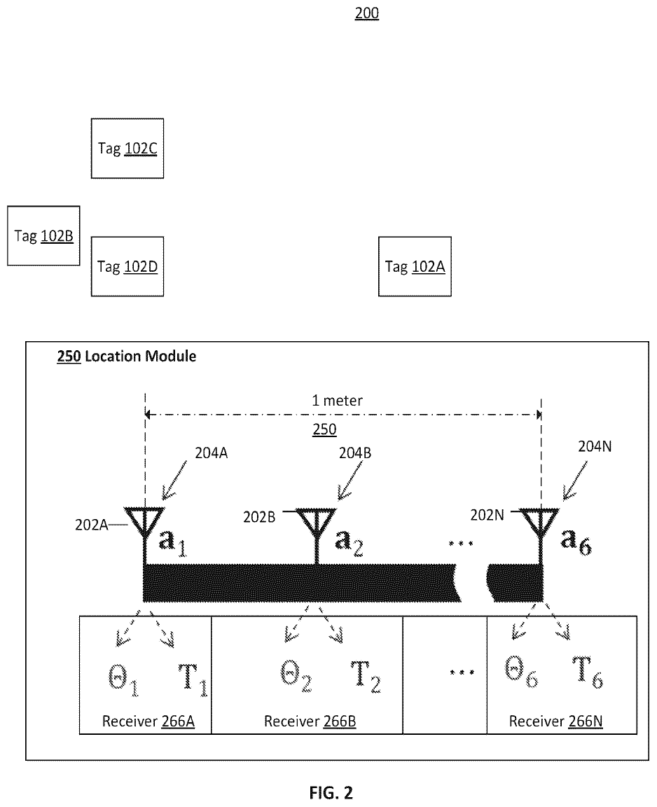

FIG. 2 depicts further depicts the system 200 including the locator 250 and one or more tags 102A-D located in a region being monitored by the locator 250. Although FIG. 2 depicts 4 tags 102A-D, the region being monitored may include other quantities of tags (e.g., 1, 2, 3, and so forth).

The tags 102A-D may each comprise a radio transmitter that emits a signal that can be received and processed by the locator 250. In some embodiments, each of the tags may also include a receiver (e.g., radio frequency (RF) receiver) as well to for example receive media access control instructions to prevent collisions among tags.

In some embodiments, each of the tags may include an antenna and a radio transmitter configured to transmit at a certain frequency. In some embodiments, each of the tags transmits using a relatively low power, such as using an ultra-wideband (UWB) radio technology (e.g., transmitting information across a wide bandwidth at about 500 MHz or above). In the case of UWB, the UWB tags are typically small active devices that transmit information using a UWB pulse that is detected by a UWB antenna and receiver at the locator 250. The UWB tags are often used to track items, such as high-value goods, keys, etc. Although some of the examples refer to UWB, the tags may use other radio technology, such as Bluetooth, Bluetooth Low Energy (LE) (e.g., a smart phone or other device transmitting an UWB, Bluetooth, and/or Bluetooth LE signal), WiFi, and the like.

In the example of FIG. 2, the locator 250 includes a plurality of antennas 202A-N. In some embodiments, the plurality of antennas comprises 6 antennas (in which case N is 6), although other quantities of antennas may be used as well (e.g., fewer than 6, such as 5, 4, 3, etc.). The plurality of antennas may be spaced in a linear manner, such that the distance between the first antenna 202A and the last antenna 204N is 1 meter or less.

In some embodiments, each of the antennas 202A-N comprises a UWB antenna coupled to a corresponding receiver 266A-N that for example decodes/demodulates the received UWB signals from the tag, performs an analog-to-digital conversion (using an analog to digital converter, ADC), and measures the PDoA and TDoA between pairs of antennas.

In operation for example, the locator's 250 antenna's 202A-N receive signals 204A-N from at least one tag, such as tag 102A. The locator measures (from the received signal) the PDoA between pairs of antennas. For example, the PDoA of the received signal at the antenna 202A and the antenna 202B is measured as θ₁; the PDoA of the received signal at the antenna 202B and another antenna is measured as θ₂; and so forth through θ₆. Meanwhile, the locator also measures TDoA between pairs of antennas 202A-N. For example, the TDoA measured using the received signal at the antenna 202A and the antenna 202B is measured as T₁; the PDoA of the received signal at the antenna 202B and another antenna is measured as T₂; and so forth through T₆. Although the PDoA measurements θ₁ through θ₆ may be used to determine the location of the tag 102A, the tag's 102A location using PDoA would, as noted herein, provide an error (e.g., an ambiguity) in the location estimate of the tag 102A for at least the reason that using PDoA the phase wraps every 2π radians as further explained below. To reduce this ambiguity in the PDoA, the locator uses the TDoA measurements to reduce the ambiguity or error associated with the PDoA to provide the location of the tag 102A within a few centimeters of less using the compact antennas 202A-N of less than 1 meter.

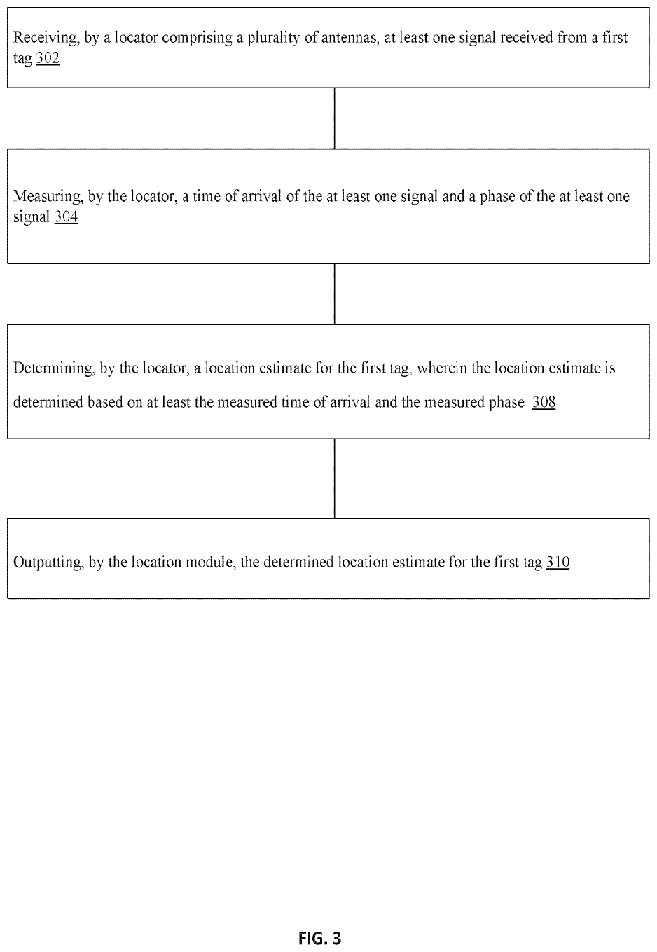

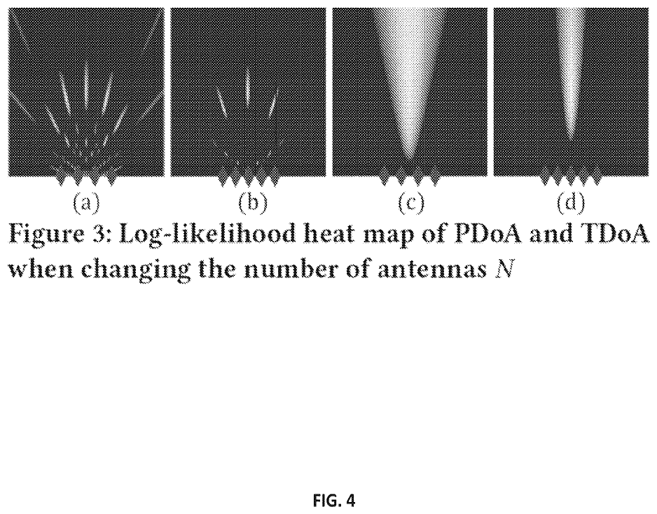

FIG. 3 depicts an example of a process for determining a location estimate for at least a first tag such as tag 102A, in accordance with some embodiments.

At 302, the process may include receiving, by a locator comprising a plurality of antennas, at least one signal received from a first tag, in accordance with some embodiments. For example, the antennas 202A-N of the locator 250 may receive at least one signal received from the tag 102A. To illustrate further, the tag 102A may transmit a signal, such as an UWB pulse, which is received as signals 204A-N at the antennas 202A-N. Alternatively, or additionally, the tag 102A may transmit signals in accordance with other radio technologies, such as Bluetooth, Bluetooth low energy, WiFi, and/or other low power and/or short-range radio technologies.

At 304, the process may include measuring, by the locator, a time of arrival of the at least one signal and a phase of the at least one signal, in accordance with some embodiments. For example, the locator may measure from the received signal (which is transmitted by the tag) a time of arrival of the at least one signal and a phase of the at least one signal. Moreover, the time of arrival measurement may be performed in the form of TDoA measurements. For example, the TDoA is measured from the received signal between antenna 202A and antenna 202B which yields T₁; the TDoA between antenna 202B and another antenna which is measured as T₂; and so forth between pairs of antennas through TDoA measurement T₆. Alternatively, or additionally, the phase measurement may be in the form of PDoA measurements. For example, the PDoA can be measured between pairs of antennas, such as between antenna 202A and antenna 202B (which provides PDoA measurement θ₁), between antenna 202B and another antenna (which provides PDoA measurement θ₂) and so forth between pairs of antennas through PDoA measurement θ₆.

At 308, the process may include determining, by the locator, a location estimate for the first tag, wherein the location estimate is determined based on at least the measured time of arrival and the measured phase, in accordance with some embodiments. As noted, the location estimate may jointly use the time arrival of the received signal and the phase of the received signal, wherein the time of arrival reduces (or eliminates) the ambiguities in the phase measurements (e.g., ambiguities caused by the 2π wrapping noted herein). In some implementations, time of arrival is measured in the form of TDoA and the phase is measured in the form of PDoA. In some embodiments, a optimization may use an objective or error function that finds an minimum error in the location estimate of the tag using the time of arrival and phase of the received signal. An example of such an error function is described with respect to Equation 2 below. The optimization may be performed in a variety of ways, such as a brute force approach, a gradient descent approach, or using packet filters (which as noted below provides a rapid solution when compared to other approaches.

At 310, the process may include outputting, by the locator, the determined location estimate for the first tag. For example, the joint optimization may provide the location estimate, which may output by the locator as the location estimate of the tag 102A.

Although FIG. 3 refers to an example using a single, first tag 102A, the process may determine location estimates for a plurality of tags, such as tag 102A, 102B, and so forth. Alternatively, or additionally, the tags may have some form of media access control to control tag transmission toward the locator. When a plurality of tags are used, the locator may receive signals from a plurality of tags, measure time of arrival and phase for each of the received signal from the plurality of tags, determine location estimates for the plurality of tags, and output the determined location estimates.

The following provides additional examples with respect to an implementation of the locator and additional details with respect to PDoA, TDoA, and an error function used to during an optimization that determines the location estimate for a tag. The following also describes another example implementation of the locator and media access control (MAC).

To predict accurate locations despite the 2π phase wrap-around associated with PDoA, the locator 250 jointly leverages PDoA and TDoA. Unlike phase measurements, time difference of arrival measurements does not suffer from the noted 2π phase wrap-around ambiguity. Specifically, the time difference of arrival (TDoA) that is measured between a pair of UWB antennas (although inaccurate in furnishing cm-level localization) can help to detect and filter out PDoA ambiguities. By fusing these time-difference and phase-difference measurements, the locator 250 can provide highly accurate (e.g., cm-level) location estimates from a single UWB signal transmission from the tag 102A (which is received as signals 204A-N by antennas 202A-N).

In an implementation for example, the locator 250 was in a 1-meter sized module comprising 6 antennas, each of which is coupled to a corresponding UWB receiver (e.g., a Decawave DW1000). Alternatively, or additionally, the locator may include a long-range spread spectrum communication transmitter (e.g., Semtech LoRa SX1272) to establish a media access control protocol among tags 102A-D using a side channel for a MAC protocol. In the example implementation, static localization error with a median and 90th percentile accuracy of 1.5 cm and 5.5 cm was achieved. Dynamic localization error with a median and 90th percentile accuracy of 2.4 cm and 5.3 cm was achieved. The localization failure rate of 0.5% was achieved, when using the MAC protocol. And a location compute latency of 1 millisecond (ms) was achieved, allowing for real-time localization (60 Hz) of 16 tags.

The locator's 250 compact antenna configuration (where the antennas 202A-N are spaced within 1 meter area so there is reduced spatial diversity) does reduce resiliency to noise, when compared to the spatially diverse antenna configuration of FIG. 1. The locator's relative lack of spatial diversity can add vulnerability to the optimization that leads to a location estimate by creating large outlier measurements and preventing few-cm scale localization. When for example two closely (e.g., less than half-wavelength) separated antennas are used, the phase difference (Δφ) can be determined or measured between a pair of antennas of the locator 250 as

$$Δϕ = \frac{2 π d}{λ} sin ( θ )$$

where θ is the incoming angle of arrival with respect to the normal of the pair of antennas,

$$d = \frac{π}{2}$$

is the distance between them, and λ is the wavelength at for example a 3.5 GHz UWB center frequency. In an example implementation of the receivers 266A-N(FIG. 2), the analog-to-digital converters (ADCs) used for UWB can have a resolution of for example 8 bits, which provides a phase resolution of 1.4° and consequently a localization resolution of 2.1 cm at a distance of 3 m from the localization module. This few-cm resolution sets a lower limit on localization accuracy. But increasing the inter-antenna separation, d, between two of the antennas 202A-N linearly increases the measured phase difference. This can be leveraged to improve the locator's localization resolution to the 1-millimeter limit, when the antenna separation is 1 meter (m).

To overcome 2π ambiguities of PDoA noted above, more antennas can be added between pair(s) of antennas. These additional antennas can help eliminate phase ambiguities by reducing the consecutive antenna distance while employing a l-m antenna array aperture. FIG. 4 presents heatmaps with the antennas represented by diamonds and the location estimates represent by the non-dark areas of the heatmaps. The location of the actual tag is in the center of each heatmap.

At FIGS. 4(a) and (b), the PDoA ambiguities that exist are shown as likely location estimates or positions of the tag 102A (e.g., as depicted by the white or non-black portions). FIG. 4 at (a) depicts the PDoA ambiguities with 4 antennas while (b) depicts closer antenna placement with 6 antennas. And FIG. 4 at (c) depicts the TDoA ambiguities with 4 antennas while (d) depicts closer antenna placement with 6 antennas. In the example of FIG. 4, two antenna arrays with spacing 33.3 cm (e.g., at (a) and (c)) and 25 cm (e.g., at (b) and (d)) for the same antenna aperture of 1 meter (e.g., the overall distance between the first antenna 102A and the last antenna. The tag's 102A actual location is at the center of the heatmap plots. Keeping the same aperture of 1 meter, there are similar measurement errors (peak widths) in both cases, but reducing separation creates fewer ambiguities at (a) and (b). Indeed, deploying 23 antennas within this 1 m, each spaced half-wavelength apart, would remove all the ambiguities at the cost of increased hardware complexity. However, the TDoA measurements at (c) and (d) are free from the ambiguities of (a) and (b), so the TDoA measurement can be leveraged to disambiguate the predictions from PDoA. FIG. 4 at (c) and (d) show the tag's 102A location likelihoods when relying on TDoA measurements only. The TDoA peak, although very erroneous (e.g., with a relatively large peak width) is unambiguous. Additionally, increasing the number of antennas reduces this error or peak width. In summary, by reducing the antenna separation (or increasing the number of antennas), we increase the separations between the ambiguities coming from PDoA measurements and tighten our peak widths coming from TDoA. As such, at a certain antenna spacing, ambiguous PDoA peaks will be wide enough to be rejected by the TDoA measurements. In some implementations, the spacing of for example 6 antennas within the 1 meter spacing is used (although other quantities of antennas may be used in a small aperture of about 1 meter as well).

As noted above, the PDoA and TDoA measurements are jointly determined and then used to reduce the error or ambiguity of the location estimate of the tag 102A. To that end, the TDoA and PDoA measurements may be jointly optimized to find the estimated location of the tag. The following provides an example of how the TDoA and PDoA measurements are jointly optimized to determine a location estimate for a tag, such as tag 102A.

The TDoA and PDoA measurements between any two pairs of antennas, such as antennas 102A-B) can be modeled as a zero-mean Gaussian with a certain standard deviation (e.g., σ_{θ}=5° and, σₜ=150 picoseconds, ps) as follows:
TDoA between a pair of antennas: t_{i,j}˜N(0, σₜ)
PDoA between a pair of antennas: θt_{i,j}˜N (0, σ_{θ}).

Moreover, given a candidate tag location (p^{→}) and receiver locations (x^{→}_i∀∈ [1, 2, . . . . N]), the expected PDoA and TDoA may be determined (e.g., computed) as follows:

$$TDoA : {\hat{t}}_{ij} = \frac{\vert \vec{p} - {\vec{x}}_{i} \vert}{c} - \frac{\vert \vec{p} - {\vec{x}}_{j} \vert}{c} \\ PDoA : {\hat{θ}}_{ij} = mod ( 2 π ( \frac{\vert \vec{p} - {\vec{x}}_{i} \vert}{λ} - \frac{\vert \vec{p} - {\vec{x}}_{j} \vert}{λ} ) , 2 π ) \qquad ( 1 )$$

where \vec{p} is the location of the tag and \ddot{x}ᵢ/\ddot{x}ⱼ are the locations of the 6 UWB antennas, such as 102A-102N, placed within a linear 1 m distance, c and λ are the speed of light and UWB wavelength, respectively. During the optimization, the location \vec{p} that gives the closest expected measurements to the actual measurements is the likely tag location, which can be represented via a minimization of \vec{p} as follows:

$${{min}_{\vec{p}} [ \begin{matrix}{\vec{e}}_{t}^{T} & {\vec{e}}_{θ}^{T}\end{matrix} ]}^{T} {\sum }^{- 1} [ \begin{matrix}{\vec{e}}_{t}^{T} & {\vec{e}}_{θ}^{T}\end{matrix} ] \qquad ( 2 )$$

where \vec{e}ₜ and \vec{x}_{iθ} measure the error between the predicted and actual measurements, and

$$\sum = diag ( {σ}_{t}^{2} , … , {σ}_{t}^{2} , {σ}_{θ}^{2} , … {σ}_{θ}^{2} )$$

is a diagonal covariance matrix containing the TDoA and PDoA measurements standard deviations. Since each antenna and corresponding receiver in the localization module is independently measuring the TDoA and PDoA, there is a diagonal covariance matrix.

A way to find this best tag location is to perform a brute force optimization using for example a grid search over the space to find a minimum point for Equation (2) above. Aiming for cm-level localization, a grid size of 1×1 mm may be used. But this exhaustive search can be time-consuming (e.g., around 61.2 s/location on a 12-core CPU), so the brute force search may preclude real-time localization in dynamic situations. Alternatively, or additionally, gradient descent-based optimization may be used to arrive at the most likely tag position. But in the case of gradient descent-based optimization, this type of optimization can fail when there is not a good initial estimate of the tag location, which is the case when looking to localize a tag in a large environment.

In some embodiments, the optimization is performed by sampling the environment more sparsely and slowly (e.g., over a few packets transmitted by the tag) converging to the “ideal” location estimate for the tag. This type of optimization may be performed using particle filters, which are used in state estimation scenarios with highly non-convex error functions and poor initialization. The core idea behind particle filters is to consider particles distributed over space as potential solutions to the location problem. At each iteration, we make a set of measurements from the UWB signals and compute which of these particles create the lowest error. A threshold is set and a set of particles providing error below this threshold are selected for the next iteration. In the next iteration, particles are resampled from this set and the cycle is repeated. In this manner, over multiple measurements, particles randomly distributed in space coverage closest to the locations which have the least error with respect to the measurements made.

Specifically, in operation using a particle filter for jointly optimizing the TDoA and PDoA to determine a tag's location, a set of particles (500 particles/meter²) is uniformly distributed in the environment (e.g., space under search) and then the error of these positions is determined using Eq. 2. When consecutive packets are received, the set of particles can be re-sampled with the lowest error and continue converging to the true locations of the tag 102A. Despite the fewer likelihood computations required, the particle filters can furnish non-real-time estimates (e.g., with a latency of 7.2 milliseconds on a 12-core CPU). To combat this problem, the locator 250 may adaptively re-sample and reduces the number of particles based on the current confidence of the location estimate, in accordance with some embodiments. As the tag's location is not known, many particles are initially required to sample the search space uniformly. However, the particles converge close to the true location of the tag over time, which improves the confidence in the location estimate of the tag. And the number of particles needed can be reduced as we no longer need to explore the space uniformly. Empirically, this adaptive particle filter implementation converges within five measurements and provides for example a location estimate with a 1.2 milliseconds (ms) latency on a 12-core CPU. In conclusion, the use of this adaptive particle filter allows us to solve the highly non-convex optimization problem stated in Eq. 2 accurately, efficiently and in real-time.

During the operation of the locator 250, low-noise phase measurements need to be acquired by the locator 250. To that end, selecting the right clock is part of ensuring a low phase noise. And, due to hardware imperfections among receivers and antennas the expected PDoA measurements (e.g., Equation 1) may not match real-world measurements. To account for these offsets, a calibration scheme may be used. Moreover, the formulation of the expected PDoA measurements may be revised. The synchronization clock is a factor affecting phase noise in the system. The phase of the UWB signal is measured by first down converting (e.g., using a mixer at the receiver of the locator) the received signal (from a tag) with the carrier signal. It is measured relative to this carrier signal by a baseband processing unit of the locator. When we consider measuring the PDoA, we look at the difference in the phase of any two receivers. In this situation, if both receivers share the same carrier clock, the PDoA measurements will be induced purely from the relative distance traveled by the signals to each receiver (per Equation 1). A simple way to achieve this is to connect the two receive antennas to the same UWB antenna and coupled receiver. However, we observed the overhead of extracting the complete channel impulse response (CIR) when implementing these systems is large (e.g., 1.2 milliseconds, ms), precluding low-latency localization. Moreover, there is API overhead to measure the data and the data extraction overhead over USB, requiring 599 us and 612 μs, respectively.

Alternatively, separate (e.g., independent) UWB antennas and receivers as depicted at FIG. 2 may be used to eliminate the need to export CIR measurements. This reduces the data acquisition latency by 4 times to 340 seconds. However, we cannot synchronize the carrier clocks on these independent modules, but instead, synchronize a lower 38.4 MHz clock leading to phase measurement errors. Via measurements with different clocks, the phase noise in this input clock can largely influence the noise in the PDoA measurements. Specifically, the phase noise of the oscillator is N^{φ}(f_{offset}) where f_{offset} is the frequency offset from the center frequency of the oscillator. Using the N^{φ}(f_{offset}), the standard deviation of clock jitter, σⱼᵢₜₜₑᵣ, can be expressed as follows.

$${σ}_{jitter} = \frac{\sqrt{2}}{2 π {f}_{osc}} \sqrt{Δ {fN}_{ϕ} ( {f}_{offset} )} \qquad ( 3 )$$

wherein Δf is the bandwidth of the measurement and f_{osc} is the oscillator frequency. The standard deviation of the phase error (σ_{φ}) and time stamping error (σₜ) may be measured as:

$${σ}_{ϕ} = \frac{c}{λ} \frac{{f}_{osc}}{2 π {f}_{s}} {σ}_{jitter} ; {σ}_{t} = \frac{{f}_{osc}}{{f}_{t}} {σ}_{jitter}$$

wherein fₛ the sampling frequency, fₜ is the frequency of the clock used for to measure time-of-arrival and c is the speed of light. The noise behavior may be used to select an appropriate clock to meet our phase and time measurement thresholds.

With respect to differences in hardware (e.g., hardware biases between the different receivers 266A-N), in Equation 1, there is provided an expression for the expected PDoA measurement, if the underlying tag and receiver locations is known. In practice, however, there is a large deviation when we compare the expected PDoA measurements with true PDoA measurements. To address these hardware bias issues, Equation 1's expected PDoA measurements can be modified as follows:

$${\hat{ϕ}}_{i , j} = mod ( \{ \frac{2 π {d}_{i}}{λ} - {α}_{i} - {β}_{j} {d}_{i}^{{γ}_{i}} \} - \{ \frac{2 π {d}_{j}}{λ} - {α}_{j} - {β}_{j} {d}_{j}^{{γ}_{j}} \} , 2 π ) , \qquad Updated Equation ( 1 )$$

wherein αᵢ, βᵢ, γᵢ are calibration parameters and dᵢ=|\vec{p}−xᵢ| is the distance between the tag and UWB receiver. We replace Equation 1 with this updated expected PDoA equation for a particle filter. To estimate these calibration parameters, a three-point calibration. First, the phase (Φ̅) measured at each UWB module is modeled according to these biases as

$${\tilde{Φ}}_{i} = {Φ}_{i} + {α}_{i} + {{β}_{i} ( {d}_{i} )}^{{γ}_{i}} , i ∈ [ 1 , N ] ,$$

wherein (Φ̅) is the calibrated phase. Next, the received phase (Φ̅) at each UWB receiver for three known locations within the space is measured. Next, a regression is used to find the expected calibration parameters, which minimize the deviation between the measured and expected phases according to the above equation. In this way, calibration can be performed to compensate for hardware biases.

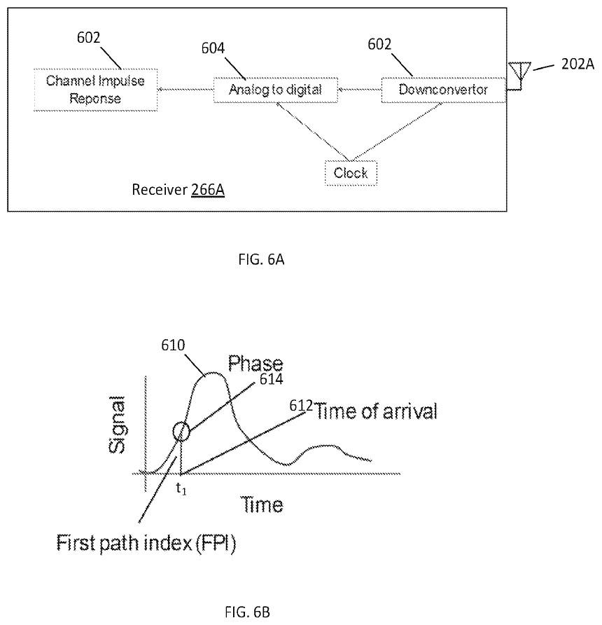

In operation, the locator 250 may encounter multipath reflections. This multipath can potentially lead to ambiguities in TDoA measurement. As UWB signals are sampled (e.g., by the ADCs) at the rate of 1 GHz (e.g., implying a time resolution of 1 ns), this fine-time resolution indicates the multipath corrupted is from reflected paths whose additional travel distance is within 30 cm. In indoor environments, finding such close-by reflected paths is unlikely, so the direct path and reflected signals are separable in the time domain. With this in mind, the time of arrival and phase of the signals are measured at the locator 250 hardware's reported first peak index, FPI (see, e.g., FIG. 6B), at the 6 UWB receivers in the locator.

In an environment with multiple tags as in the case of tags 102A-D, packet collisions (from the transmitted signals from the tags) can occur, which impacts the locator's 250 ability to localize a given tag. In some embodiments, each tag is allowed to transmit arbitrarily (although this may result in the noted packet collisions). In some embodiments, there is a media access control (MAC) protocol among the tags. For example, the individual tags may be scheduled to transmit towards the locator at specific time intervals and leverage time-division multiple access (TDMA) to prevent packet collisions. For example, to enable a total localization rate of 1000 Hz at the locator's 250 receiver means localizing 1000 tags at a rate of 1 Hz or 10 tags at 100 Hz. In some embodiments, a side channel, for example, a side RF channel that is separate from the UWB packets being transmitted by the tags 102A-D. The side-channel may be implemented as a low-power wide area network to provide MAC control over the tags. In this example, a MAC controller is used to onboard new tags, provide time synchronization, and apply corrections to tags that deviate from their time slots. Alternatively, the MAC control can be provided to allow for independent tag management and localization functions. For example, a side channel at 900 MHz may be used as while the UWB tag transmission are at 3.5 GHZ. The side channel may be implemented as a LoRa (long range spread spectrum) radio technology, although other low power radio technologies may be used as well, such as Bluetooth, Bluetooth Low Energy, and/or the like. In this side channel can provide reliable and low-power MAC control for multiple tags.

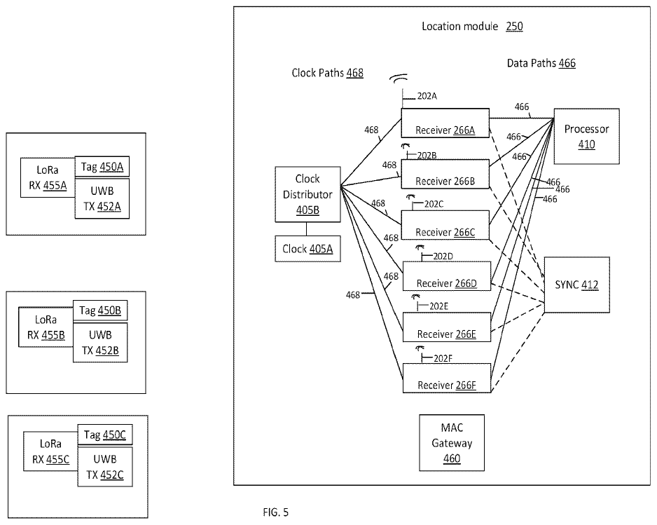

For example, the MAC protocol may comprise a “centralized” MAC controller (or gateway), which is deployed at the locator 250. At the tags 102A-D, a LoRa receiver (“LoRa RX”) may be coupled to each tag. FIG. 5 depicts the tag 450A including the UWB transmitter (TX) 452A and a side channel for MAC control provided by the LoRa RX 455A. FIG. 5 shows similar configurations for tags 450B and 450C.

At FIG. 5, the tag 450A may transmit one or more “blink” packets at 60 Hz (using for example the UWB transmitter 452A), with each transmitted frame having 14 bytes of payload including packet number and a MAC address to facilitate and test the MAC protocol. Operating in parallel, the LoRa RX 455A receives time-sync packets from the MAC gateway 460 maintaining the UWB transmit slots and providing medium access control. An interrupt pin is raised by LoRa RX 455A to initiate a UWB “blink” transmission at the accurate time slot.

At FIG. 5, the MAC gateway 460 is used to provide discovery and on-boarding. For example, new tags transmit one or more beacon packets to announce their presence. Subsequently, the gateway 460 invites these new tags to join the network by assigning a specific transmit time slot to transmit the UWB localization packets. The number and duration of a transmit slot is determined by the maximum number of tags and their localization rate. The MAC gateway 460 may also provide a global time sync among the tags. However, each tag can have a consistent notion of time slots, which requires a global time synchronization within the accuracy of at least half the slot width. For example, the gateway 460 may transmit time-sync packets every 100 s, the time it takes for the 5 ppm clocks to drift by 500 microseconds, μs. The LoRa RX 455A receives these sync packets and corrects for its clock drift. The MAC gateway 460 may also correct erroneous tags. For example, the MAC gateway 460 may provide a correction mechanism to re-slot colliding tags. For example, a time-sync failure at tags may result in transmission at an incorrect time slot and this may lead to consistent collisions among groups of tags. By tracking the tags which suffer consistent collisions, the gateway 460 may broadcast a correction packet over LoRa side channel to re-slot the erroneous tag.

At FIG. 5, there is depicted an example implementation of the locator 250 which includes the MAC gateway 460 that is used to provide MAC control among the tags 450A-C. As noted, the antennas of the receivers 266A-266F may be sized within 1 m distance as noted above. This compact antenna aperture can allow the localization module to be deployed within for example common electronics such as a TV's soundbars. To illustrate further, each UWB receiver may comprise an antenna and receiver circuitry. And the UWB receiver may be at a center frequency of 3.4 GHz, a 499.2 MHz bandwidth, and a preamble length of 1-24. The UWB receivers may be synchronized to a common clock 405A via a clock distributor 405B. The UWB receiver's may be re-synchronized by SYNC 412 to reset the time on the UWB receiver and thus reduce bias in TDoA measurements. When each UWB receiver receives a single signal for localization from the UWB tag, the UWB receiver reports the first-peak-index (FPI) of the direct path in the channel impulse response's peak, the signal phase at this point, time of arrival (RXTIME), via the data path 466 to the processor 410.

FIG. 6A depicts an example of the antenna and receiver of a locator, in accordance with some embodiments. In the example of FIG. 6A, the downconverter 602A down converts the signal (which is transmitted by a tag, such as tag 102A, and received at antenna 102A) into an intermediate frequency (IF). The IF is provided to an analog-to-digital converter 604, which converts the IF (which is in an analog form) into an IF in a digital form. The digitized IF represents the CIR of the received signal from the tag. With the CIR, measurements, such as time of arrival of the received signal and phase difference of the received signal may be performed, in accordance with some embodiments. FIG. 6B depicts an example plot 610 of the CIR. The CIR plot 610 represents a snapshot (e.g., at time t) of the CIR of the received tag signal. The receiver 266A may measure time of arrival 612 of the received signal. In the digitized representation of the CIR, the CIR of the received signal at time t₁ includes a real part and an imaginary part. From the imaginary part, a phase 614 measurement of the received tag signal may be determined.

In some testing of the system of FIG. 5, the locator 250 can achieve 1.5 cm and 5.5 cm accuracy at the median and 90th percentile in static conditions. Further, in moving conditions, locator provides an accuracy of 2.4 cm and 5.3 cm at the median and 90th percentile.

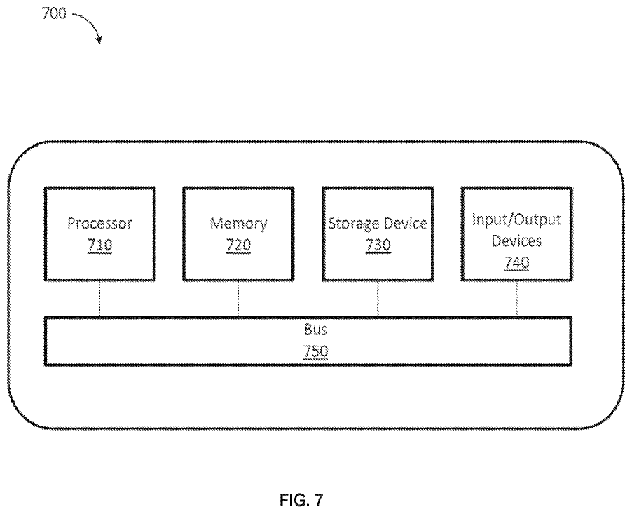

FIG. 7 depicts a block diagram illustrating a computing system 700, in accordance with some embodiments. The computing system may provide a processor 410 at the locator. For example, the computing system may be used to perform measurements of time of arrival and/or phase as well as the optimization that determines the location estimate using for example a brute force search, gradient descent, or particle filters. The computing system 700 can include a processor 710, a memory 720, a storage device 730, and input/output devices 740. The processor 710, the memory 720, the storage device 730, and the input/output devices 740 can be interconnected via a system bus 750. The processor 710 is capable of processing instructions for execution within the computing system 700. In some implementations of the current subject matter, the processor 710 can be a single-threaded processor. Alternately, the processor 710 can be a multi-threaded processor. The process may be a multi-core processor have a plurality or processors or a single core processor. Alternatively, or additionally, the processor 710 can be a graphics processor unit (GPU), an AI chip, and/or the like. The processor 710 is capable of processing instructions stored in the memory 720 and/or on the storage device 730 to display graphical information for a user interface provided via the input/output device 740. The memory 720 is a computer readable medium such as volatile or non-volatile that stores information within the computing system 700. The memory 720 can store data structures representing configuration object databases, for example. The storage device 730 is capable of providing persistent storage for the computing system 700. The storage device 730 can be a floppy disk device, a hard disk device, an optical disk device, or a tape device, or other suitable persistent storage means. The input/output device 740 provides input/output operations for the computing system 700. In some implementations of the current subject matter, the input/output device 740 includes a keyboard and/or pointing device. In various implementations, the input/output device 740 includes a display unit for displaying graphical user interfaces. According to some implementations of the current subject matter, the input/output device 740 can provide input/output operations for a network device. For example, the input/output device 740 can include Ethernet ports or other networking ports to communicate with one or more wired and/or wireless networks (e.g., a local area network (LAN), a wide area network (WAN), the Internet).

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1. A method comprising:
receiving, by a locator comprising a plurality of antennas, at least one signal received from a first tag;
measuring, by the locator, a time of arrival of the at least one signal and a phase of the at least one signal;
determining, by the locator, a location estimate for the first tag, wherein the location estimate is determined based on at least the measured time of arrival and the measured phase; and
outputting, by the locator, the determined location estimate for the first tag.

Example 2. The method of Example 1, wherein the plurality of antennas is configured within a 1 meter or less distance.

Example 3. The method of any of Examples 1-2, wherein the measuring further comprises determining, using the time of arrival of the at least one signal, a time difference of arrival between at least a pair of antennas of the plurality of antennas.

Example 4. The method of any of Examples 1-3, wherein the measuring further comprises determining, using the phase of the at least one signal, a phase difference of arrival between at least a pair of antennas of the plurality of antennas.

Example 5. The method of any of Examples 1-4, wherein the location estimate is determined using the phase difference of arrival between at least the pair of antennas and the time difference of arrival between at least the pair of antennas.

Example 6. The method of any of Examples 1-5, wherein the location estimate is determined using an optimization of at least the phase difference of arrival and the time difference of arrival.

Example 7. The method of any of Examples 1-6, wherein the optimization uses packet filters to determine the location estimate.

Example 8. The method of any of Examples 1-7, wherein the at least one signal is an ultrawideband pulse signal, a Bluetooth signal, WiFi, or a Bluetooth low energy signal.

Example 9. The method of any of Examples 1-8, wherein the plurality of antennas is configured within a 1 meter or less distance.

Example 10. The method of any of Examples 1-9 further comprising: controlling transmission of the first tag and a second tag; receiving, by the locator, at least another signal from the second tag; determining, by the locator, the location estimates for the first tag and a second location estimate for the second tag; and outputting, by the locator, the determined location estimates for the first tag and the second tag.

Example 11. A system comprising:
at least a plurality of antennas each coupled to a receiver configured to receive at least one signal received from at least a first tag; and
at least one processor and at least one memory including instructions which when executed by the at least one processor causes operations comprising:
measuring a time of arrival of the at least one signal and a phase of the at least one signal;
determining a location estimate for the first tag, wherein the location estimate is determined based on at least the measured time of arrival and the measured phase; and
outputting the determined location estimate for the first tag.

Example 12. The system of claim 11, wherein the plurality of antennas is configured within a 1 meter or less distance.

Example 13. The system of any of Examples 11-12, wherein the measuring further comprises determining, using the time of arrival of the at least one signal, a time difference of arrival between at least a pair of antennas of the plurality of antennas.

Example 14. The system of any of Examples 11-13, wherein the measuring further comprises determining, using the phase of the at least one signal, a phase difference of arrival between at least a pair of antennas of the plurality of antennas.

Example 15. The system of any of Examples 11-14, wherein the location estimate is determined using the phase difference of arrival between at least the pair of antennas and the time difference of arrival between at least the pair of antennas.

Example 16. The system of any of Examples 11-15, wherein the location estimate is determined using an optimization of at least the phase difference of arrival and the time difference of arrival.

Example 17. The system of any of Examples 11-16, wherein the optimization uses packet filters to determine the location estimate.

Example 18. The system of any of Examples 11-17, wherein the at least one signal is an ultrawideband pulse signal, a Bluetooth signal, WiFi, or a Bluetooth low energy signal.

Example 19. The system of any of Examples 11-18, wherein the plurality of antennas is configured within a 1 meter or less distance.

Example 20. The system of any of Examples 11-19 further comprising: controlling transmission of the first tag and a second tag; receiving, by the locator, at least another signal from the second tag; determining, by the locator, the location estimates for the first tag and a second location estimate for the second tag; and outputting, by the locator, the determined location estimates for the first tag and the second tag.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed:

1. A method comprising:
receiving, by a locator comprising a plurality of antennas, at least one signal received from a first tag;
measuring, by the locator, a time of arrival of the at least one signal and a phase of the at least one signal;
determining, by the locator, a location estimate for the first tag, wherein the location estimate is determined based on at least the measured time of arrival and the measured phase; and
outputting, by the locator, the determined location estimate for the first tag.

2. The method of claim 1, wherein the plurality of antennas is configured within a 1 meter or less distance.

3. The method of claim 1, wherein the measuring further comprises determining, using the time of arrival of the at least one signal, a time difference of arrival between at least a pair of antennas of the plurality of antennas.

4. The method of claim 3, wherein the measuring further comprises determining, using the phase of the at least one signal, a phase difference of arrival between at least a pair of antennas of the plurality of antennas.

5. The method of claim 4, wherein the location estimate is determined using the phase difference of arrival between at least the pair of antennas and the time difference of arrival between at least the pair of antennas.

6. The method of claim 5, wherein the location estimate is determined using an optimization of at least the phase difference of arrival and the time difference of arrival.

7. The method of claim 6, wherein the optimization uses packet filters to determine the location estimate.

8. The method of claim 1, wherein the at least one signal is an ultrawideband pulse signal, a Bluetooth signal, WiFi, or a Bluetooth low energy signal.

9. The method of claim 1, wherein the plurality of antennas is configured within a 1 meter or less distance.

10. The method of claim 1 further comprising:
controlling transmission of the first tag and a second tag;
receiving, by the locator, at least another signal from the second tag;
determining, by the locator, the location estimates for the first tag and a second location estimate for the second tag; and
outputting, by the locator, the determined location estimates for the first tag and the second tag. A system comprising:
at least a plurality of antennas each coupled to a receiver configured to receive at least one signal received from at least a first tag; and
at least one processor and at least one memory including instructions which when executed by the at least one processor causes operations comprising:
measuring a time of arrival of the at least one signal and a phase of the at least one signal;
determining a location estimate for the first tag, wherein the location estimate is determined based on at least the measured time of arrival and the measured phase; and
outputting the determined location estimate for the first tag.

11. The system of claim 11, wherein the plurality of antennas is configured within a 1 meter or less distance.

12. The system of claim 11, wherein the measuring further comprises determining, using the time of arrival of the at least one signal, a time difference of arrival between at least a pair of antennas of the plurality of antennas.

13. The system of claim 13, wherein the measuring further comprises determining, using the phase of the at least one signal, a phase difference of arrival between at least a pair of antennas of the plurality of antennas.

14. The system of claim 14, wherein the location estimate is determined using the phase difference of arrival between at least the pair of antennas and the time difference of arrival between at least the pair of antennas.

15. The system of claim 15, wherein the location estimate is determined using an optimization of at least the phase difference of arrival and the time difference of arrival.

16. The system of claim 16, wherein the optimization uses packet filters to determine the location estimate.

17. The system of claim 11, wherein the at least one signal is an ultrawideband pulse signal, a Bluetooth signal, WiFi, or a Bluetooth low energy signal.

18. The system of claim 11, wherein the plurality of antennas is configured within a 1 meter or less distance.

19. The system of claim 11 further comprising:
controlling transmission of the first tag and a second tag;
receiving, by the locator, at least another signal from the second tag;
determining, by the locator, the location estimates for the first tag and a second location estimate for the second tag; and
outputting, by the locator, the determined location estimates for the first tag and the second tag.
